(19) United States
(12) Patent Application Publication
(10) Pub. No.: US 2021/0078280 A1
(43) Pub. Date: Mar. 18, 2021

(54) MOLDED PAPER CUSHIONING AND METHOD OF MANUFACTURE

(71) Applicant: Andrew Bergmann, Irvington, NY (US)

(72) Inventor: Andrew Bergmann, Irvington, NY (US)

(21) Appl. No.: 16/571,114

(22) Filed: Sep. 14, 2019

(51) Int. Cl. B31D 5/00; B65D 81/02

(52) U.S. Cl. CPC B31D 5/0004; B65D 81/051; B65D 65/44

(57) ABSTRACT

A molded paper structure that provides cushioning and the method of manufacturing. The molded paper cushioning is flexible, with a continuous surface, without the use of folds or external adhesives. In the method of manufacture, paper sheet material is soaked with water and subsequently passed through a compression mold that forms the paper into a cushioning shape.

### BACKGROUND OF THE INVENTION

Cushioning and packaging materials are often utilized in the process of moving or shipping items from one location to another to avoid damaging the items in transit. Common forms of cushioning materials include plastic-based bubble sheets, synthetic foam pieces and foam blocks, which are generally not recyclable or biodegradable. After use, these packing materials are often disposed of and ultimately discarded in landfills.

Paper-based cushioning materials are less popular, but can be both recyclable and biodegradable. Current paper-based packing materials can be limiting due to various factors. Corrugated paper is inflexible, relatively heavy, and requires adhering multiple layers together. Crumpled and shredded paper materials can be messy and more difficult to ensure consistent coverage and protection across the surface of an item.

Other means of forming paper-based cushioning can be complex to construct and therefore costly and laborious to produce, due to cutting, crumpling, folding, or the adhesion of multiple pieces of paper together. In addition, paper-based structures can be rigid and lose form with minimal pressure.

### SUMMARY OF THE INVENTION

The present invention provides a novel cushioning product of molded paper and the method for molding sheet-based material such as paper.

Molded paper cushioning is formed in a continuous shape of alternating concave and convex bumps. Wave formations along the width and length axes form together to create the alternating bump shapes. The cushioning surface is smooth and continuous without folds, cuts, or external adhesives.

The cushioning material is molded through a process of soaking paper stock material with water and subsequently passing it through a compression mold to form the paper into a shape.

An object of the invention is to provide flexible cushioning that can be used to protect items and products.

Another object of the invention is to provide a lightweight, low-cost cushioning material to make shipping easier and more economical.

A still further object of the invention is to provide a natural alternative to cushioning materials made of synthetic compounds. Molded paper cushioning can be produced with recycled materials and can biodegrade or be recycled after use.

A still further object of the invention is to provide cushioning that has minimal surface area contact with items and products it protects.

Other objects and advantages of the invention will be apparent from the following description taken in conjunction with the accompanying drawings herein.

### BRIEF DESCRIPTION OF THE DRAWINGS

FIG. 1 is a perspective view of molded paper cushioning.

FIG. 2 is a top plan view of molded paper cushioning.

FIG. 3 is a front sectional view of molded paper cushioning.

FIG. 4 is a side sectional view of molded paper cushioning.

FIG. 5 is a front sectional view that schematically depicts the paper molding machine.

FIG. 6 is a top plan view that schematically depicts the paper molding machine.

### DETAILED DESCRIPTION OF THE PREFERRED EMBODIMENTS

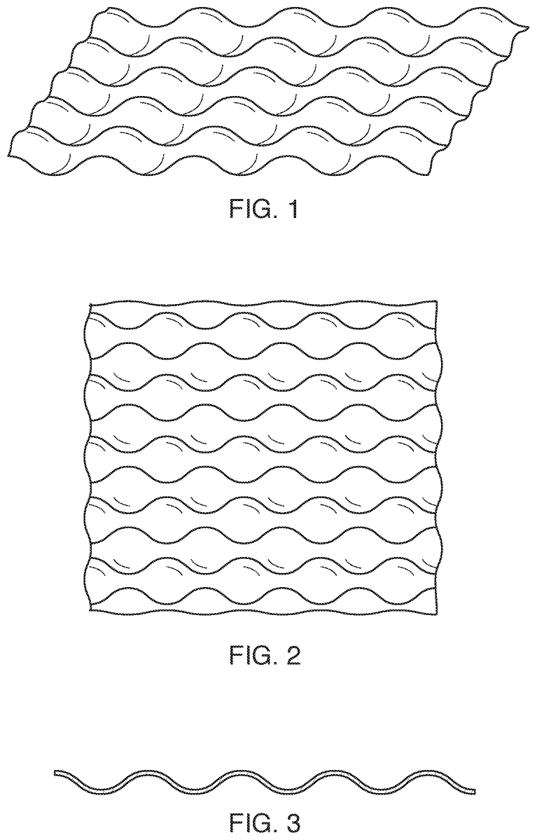

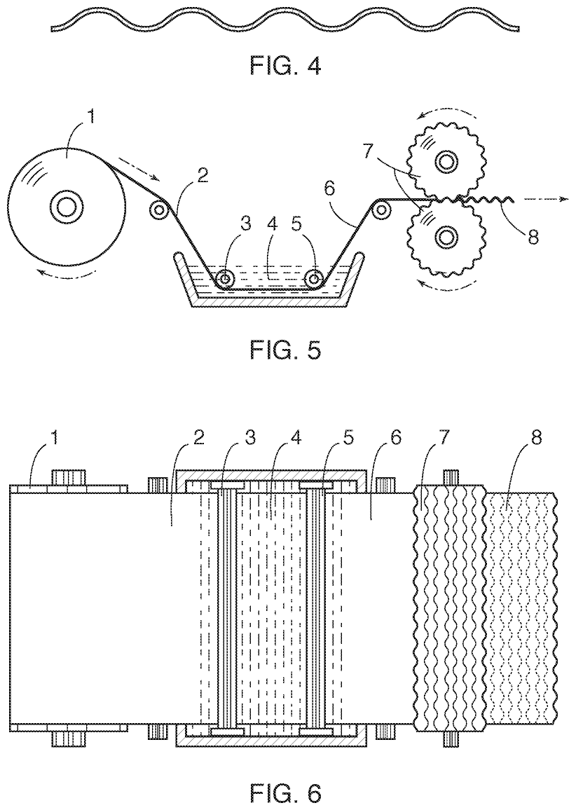

Molded paper cushioning is shown in FIGS. 1 through 4. The molded paper is formed in a continuous shape of alternating concave and convex bumps. Wave formations along the width and length axes form together to create the alternating bump shapes. The cushioning surface is smooth and continuous without folds, cuts, or external adhesives.

The method in which molded paper cushioning is produced is shown in FIGS. 5 and 6. A roll of sheet-like stock material such as paper 1 sits on a spindle that can rotate freely. The paper material advances off of the roll 2 as it is pulled through the system by the compression mold rollers 7.

The stock material is guided by a roller 3 and submerged into a bath of water 4. It is held beneath the surface of the water by another roller 5, soaking the paper material and softening the fibers. Once the paper material is saturated, it continues out of the bath 6 and proceeds into the rotating compression mold 7.

The compression mold 7 is comprised of a pair of mated shaped rollers and forms the paper into the cushioning material 8 which is extruded from the mold.

What is claimed is:

1. A cushioning material made of molded paper.

2. A molded paper material formed in alternating concave and convex bumps.

3. The method of producing molded paper cushioning by soaking paper stock material with water and passing it through a compression mold.

4. The method for molding paper stock material into a formed shape by soaking paper stock material with water and passing it through a compression mold.
